(19) United States
(12) Patent Application Publication
(10) Pub. No.: US 2021/0319743 A1
(43) Pub. Date: Oct. 14, 2021

(54) ELECTRONIC DEVICE AND DRIVING METHOD OF DISPLAY PANEL

(71) Applicant: Innolux Corporation, Miao-Li County (TW)

(72) Inventors: Wei-Ting Chou, Miao-Li County (TW); Ying-Wen Yang, Miao-Li County (TW)

(73) Assignee: Innolux Corporation, Miao-Li County (TW)

(21) Appl. No.: 17/211,801

(22) Filed: Mar. 24, 2021

(30) Foreign Application Priority Data
Apr. 9, 2020 (CN) 202010276038.7

(51) Int. Cl. G09G 3/20

(52) U.S. Cl. CPC G09G 3/2096; G09G 2310/0275; G09G 2310/0267; G09G 2340/0435

(57) ABSTRACT

An electronic device and a driving method of a display panel are provided. The electronic device includes a display panel and a driver. The driver is configured to convert a first image signal into a second image signal, output the second image signal to the display panel, and enable the display panel to display an image frame according to the second image signal. Converting the first image signal into the second image signal includes duplicating the first image signal by n times according to a first direction, and simultaneously scanning m adjacent scan lines to simultaneously drive m adjacent pixel units. The first image signal has a first image resolution of A×B, and the second image signal has a second image resolution of m×n×A×B, where m is a positive integer greater than or equal to 2, n is a positive number, and A and B are positive integers.

### CROSS-REFERENCE TO RELATED APPLICATION

This application claims the priority benefit of China application serial no. 202010276038.7, filed on Apr. 9, 2020. The entirety of the above-mentioned patent application is hereby incorporated by reference herein and made a part of this specification.

### BACKGROUND

### Technical Field

The disclosure relates to a display technology, and particularly relates to an electronic device and a driving method of a display panel.

### Description of Related Art

Display device includes a system board and a display module. Generally, after the system board receives an image signal provided by an external image signal source, the system board performs signal processing on the image signal. The system board provides an optimized image signal to the display module to perform a display operation. However, along with an increasing demand for display quality, there are more and more circuit modules configured to optimize the image signal on the system board to perform different optimizations on the image signal, resulting in increase of performance requirement and manufacturing cost of the system board. Therefore, regarding the issue of how to enable the display module to implement the function of optimizing the image signal so as to reduce the performance requirement and manufacturing cost of the system board, solutions of several embodiments are provided below.

### SUMMARY

The disclosure is directed to an electronic device and a driving method of a display panel, which are adapted to provide a good display effect.

According to an embodiment of the disclosure, the electronic device includes a display panel and a driver. The display panel includes a plurality of scan lines and a plurality of data lines. The plurality of data lines are arranged along a first direction. The plurality of scan lines include m adjacent scan lines, and the m adjacent scan lines are respectively coupled to m adjacent pixel units in the plurality of pixel units, where m is a positive integer greater than or equal to 2. The driver is coupled to the display panel. The driver is configured to convert a first image signal into a second image signal, output the second image signal to the display panel, and enable the display panel to display an image frame according to the second image signal. A method of converting the first image signal into the second image signal includes duplicating the first image signal by n times according to the first direction, and simultaneously scanning the m adjacent scan lines to simultaneously drive the m adjacent pixel units, where the first image signal has a first image resolution of A×B, and the second image signal has a second image resolution of m×n×A×B, where n is a positive number, and A and B are positive integers.

According to an embodiment of the disclosure, the driving method of the display panel includes following steps. The first image signal is duplicated by n times according to a first direction, and m adjacent scan lines are simultaneously scanned to simultaneously drive m adjacent pixel units to convert the first image signal into a second image signal, where the first image signal has a first image resolution of A×B, and the second image signal has a second image resolution of m×n×A×B, where n is a positive number, and A and B are positive integers. The second image signal is output to the display panel, and the display panel is driven to display an image frame according to the second image signal.

This disclosure may be understood by referring to the following detailed description in collaboration with the accompanying drawings. It should be noted that for the sake of easy understanding and simplicity of the drawings, the multiple drawings in the disclosure only depict a part of the display device, and specific components in the drawings are not drawn according to actual scales. In addition, the number and size of each component in the drawing are only for illustration, and are not used to limit the scope of the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of an electronic device according to an embodiment of the disclosure.

FIG. 2 is a schematic diagram of image data of a first image signal and a second image signal according to an embodiment of the disclosure.

FIG. 3 is a schematic diagram of a plurality of pixel units of a display panel according to an embodiment of the disclosure.

FIG. 4 is a signal timing diagram of the embodiment of FIG. 3 of the disclosure.

FIG. 5 is a flowchart of a driving method of a display panel according to an embodiment of the disclosure.

### DESCRIPTION OF THE EMBODIMENTS

Certain terms are used throughout the specification of the disclosure and the appended claims to refer to specific components. Those skilled in the art should understand that display device manufacturers may probably use different names to refer to the same components. This specification is not intended to distinguish between components that have the same function but different names. In the following specification and claims, the terms “containing”, “including”, etc., are open terms, so that they should be interpreted as meaning of “including but not limited to . . . ”.

In some embodiments of the disclosure, terms related to bonding and connection, such as “couple”, “interconnect”, etc., unless specifically defined, may mean that two structures are in direct contact, or that the two structures are not in direct contact, and there are other structures disposed between the above two structures. And, the terms related to bonding and connection may also include the case that both of the structures are movable or both structures are fixed. In addition, the term “couple” includes any direct and indirect electrical connection means.

Ordinal numbers used in the specification and claims, such as “first”, “second”, etc., are used to modify components, and they do not mean or represent the, or these, components have any previous ordinal numbers, nor do they represents an order of a certain component and another component, or an order of a manufacturing method. The use of these ordinal numbers is only used to clearly distinguish a component with a certain name from another component with the same name. The same terms may not be used in the claims and the specification. Accordingly, a first component in the specification may be a second component in the claims. It should be noted that in the following embodiments, technical features of several different embodiments may be replaced, recombined, and mixed to complete other embodiments without departing from the spirit of the disclosure.

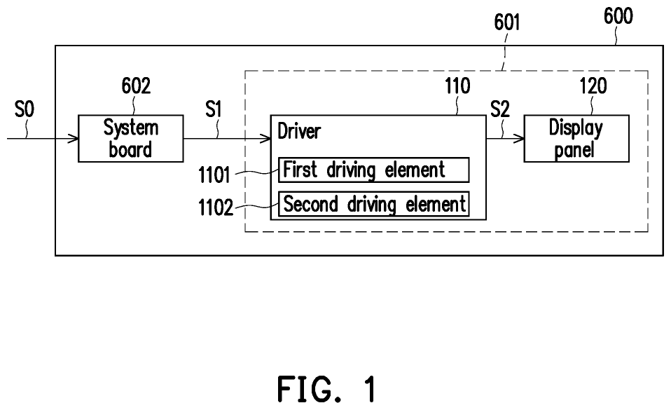

FIG. 1 is a schematic diagram of an electronic device according to an embodiment of the disclosure. Referring to FIG. 1, an electronic device 600 includes a display module 601 and a system board 602. The display module 601 includes a driver 110 and a display panel 120. The system board 602 is coupled to the display module 601. In detail, the system board 602 is coupled to the driver 110 of the display module 601. The system board 602 may perform signal processing on image signals, and may include a system on chip (SOC). In the embodiment, the system board 602 may receive an original image signal S0 from the outside via a transmission interface (not shown). The transmission interface may be, for example, a high definition multimedia interface (HDMI). The system board 602 may perform related image processing on the original image signal S0 to output a first image signal S1 with a first image resolution to the driver 110. According to some embodiments, the image processing of the system board 602 may not include changing the image resolution. Alternatively, the system board 602 may not perform the related image processing on the original image signal S0, and is only used to take the original image signal S0 as the first image signal S1 for outputting to the driver 110.

According to some embodiments, the display panel 120 may be, for example, a liquid crystal panel, an organic light emitting diode (OLED) panel, an inorganic light emitting diode (ILED) panel, a mini-LED panel, a micro-LED panel, a quantum dot (QD) panel, a QLED/QDLED panel or an electro-phoretic panel, etc, but the disclosure is not limited thereto.

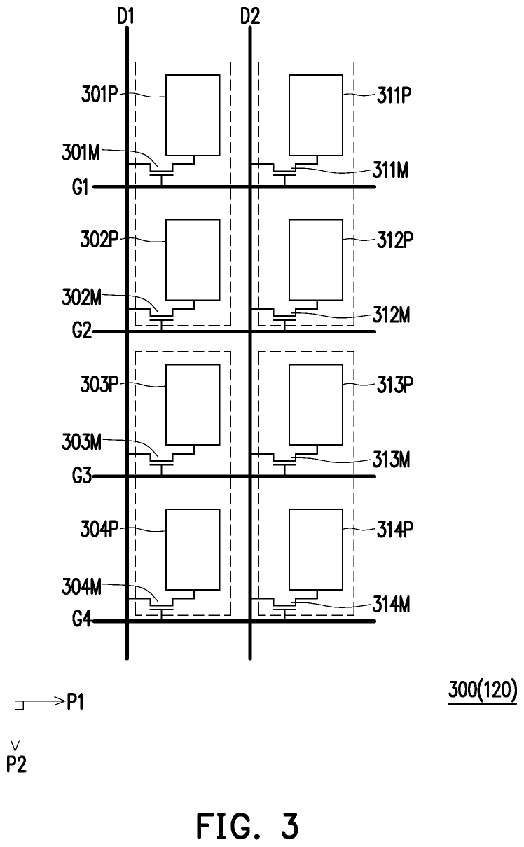

As shown in FIG. 3, a part of the display panel 120 may include a pixel array 300 shown in FIG. 3. The pixel array 300 includes a plurality of scan lines G1-G4, a plurality of data lines D1, D2, and a plurality of pixel units 301P-304P, 311P-314P defined by the scan lines G1-G4 and the data lines D1-D2. The data lines D1 and D2 are arranged along a first direction P1. The scan lines G1-G4 are arranged in a second direction P2. The first direction P1 and the second direction P2 may be different, for example, may be perpendicular to each other. According to some embodiments, the first direction P1 may be referred to as a horizontal direction, and the second direction P2 may be referred to as a vertical direction. The driver 110 is coupled to the display panel 120, and may convert the first image signal S1 into a second image signal S2, and output the second image signal S2 to the display panel 120, so that the display panel 120 displays an image frame according to the second image signal S2. The driver 110 may include a first driving element 1101 and a second driving element 1102. The way the driver 110 converts the first image signal S1 into the second image signal S2 includes duplicating the first image signal S1 by n times according to the first direction P1, and simultaneously scanning m adjacent scan lines to simultaneously drive m adjacent pixel units.

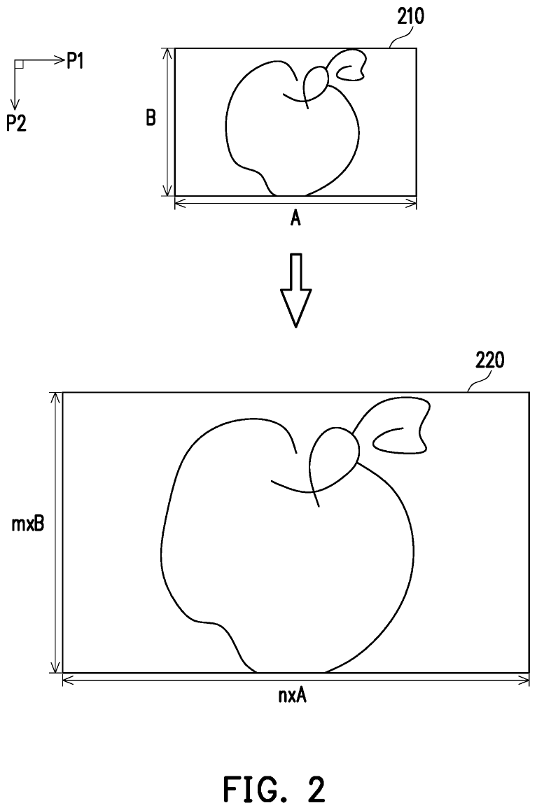

FIG. 2 is a schematic diagram of image data of a first image signal and a second image signal according to an embodiment of the disclosure. In detail, referring to FIG. 1 and FIG. 2, for example, the first image signal S1 may be used, for example, to present first image data 210 with a first image resolution of A×B as shown in FIG. 2, where A and B are positive integers. The second image signal S2 may be used, for example, to present second image data 220 with a second image resolution of m×n×A×B as shown in FIG. 2. The first driving element 1101 of the driver 110 may duplicate the first image signal S1 by n times according to the first direction P1 (the horizontal direction), where n is a positive number, so that a number of pixels of the second image data 220 in the first direction P1 (the horizontal direction) is increased to n×A. The second driving element 1102 of the driver 110 may simultaneously scan m adjacent scan lines to simultaneously drive m adjacent pixel units, where m is a positive integer greater than or equal to 2, so that a number of pixels of the second image data 220 in the second direction P2 (the vertical direction) is increased to m×B. Namely, the first image signal S1 with the first image resolution of A×B may be converted into the second image signal S2 with the second image resolution of m×n×A×B by the driver 110.

It should be noted that the first image resolution of the first image signal S1 and the second image resolution of the second image signal S2 refer to resolutions of the image data, which are not display results directly presented by the display panel 120. In the embodiment, the driver 110 may convert the first image signal S1 with the first image resolution of A×B into the second image signal S2 with the second image resolution of m×n×A×B, and the display panel 120 displays an image frame according to the second image signal S2. The second image resolution may be greater than the first image resolution. In other words, in the embodiment, the driver 110 may receive an image signal with a lower image resolution, and process the image signal, so that the display panel 120 may display an image frame with a higher image resolution. Therefore, the electronic device 600 of the embodiment may have a function of increasing the image resolution of the received image signal, thereby providing a display effect with high image resolution.

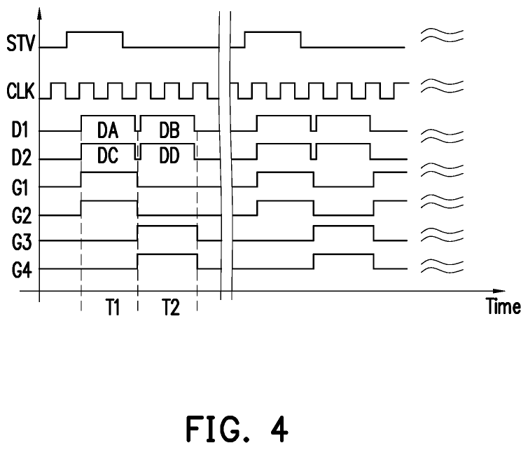

FIG. 3 is a schematic diagram of a plurality of pixel units of a display panel according to an embodiment of the disclosure. FIG. 4 is a signal timing diagram of the embodiment of FIG. 3 of the disclosure. Hereinafter, FIG. 3 and FIG. 4 are used to illustrate a driving method of the pixel units of the display panel of the disclosure. Referring to FIG. 1, FIG. 3, and FIG. 4, a part of the display panel 120 may include the pixel array 300 shown in FIG. 3, and the pixel array 300 includes the pixel units 301P-304P and 311P-314P arranged in an array. In FIG. 3, the scan line G1 is coupled to control terminals of switching elements 301M and 311M. The scan line G2 is coupled to control terminals of switching elements 302M and 312M. The scan line G3 is coupled to control terminals of switching elements 303M and 313M. The scan line G4 is coupled to control terminals of switching elements 304M and 314M. The data line D1 is coupled to first terminals of the switching elements 301M-304M. The data line D2 is coupled to first terminals of the switching elements 311M-314M. Second terminals of the switching elements 301M-304M and 311M-314M are respectively coupled to the pixel units 301P-304P and 311P-314P. The above-mentioned switching elements may be, for example, transistors, but the disclosure is not limited thereto. In the embodiment, the driver 110 may further include a plurality of shift registers, and the shift registers may respectively receive a start signal STV and a clock signal CLK, so as to respectively generate driving signals to the scan lines G1-G4 according to the start signal STV and the clock signal CLK.

A situation of n=2 and m=2 in FIG. 2 is taken as an example for description. A pixel number A of the first image data 210 in the horizontal direction P1 may be, for example, 1920 (i.e., the horizontal resolution is 1920), and a pixel number B in the vertical direction P2 may be, for example, 1080 (i.e., the vertical resolution is 1080). The first driving element 1101 of the driver 110 may duplicate the first image signal S1 by 2 times (n=2) along the first direction P1, and the pixel number of the second image data 220 in the horizontal direction P1 may be increased to, for example, 3840 (i.e., the horizontal resolution is 3840). As shown in FIG. 3, the second driving element 1102 of the driver 110 simultaneously scans two (m=2) adjacent scan lines G1 and G2 to simultaneously drive two (m=2) adjacent pixel units 301P and 302P. Referring to FIG. 3 and FIG. 4 at the same time, in detail, the driver 110 may simultaneously scan the two scan lines G1 and G2. In this way, in a time interval T1, pixel data DA is provided to the adjacent pixel units 301P and 302P via the data line D1. Similarly, in the time interval T1, pixel data DC is provided to the adjacent pixel units 311P and 312P via the data line D2. Then, in a time interval T2, the driver 110 may simultaneously scan the other two scan lines G3 and G4, and pixel data DB is provided to the pixel units 303P and 304P via the data line D1. Similarly, in the time interval T2, pixel data DD is provided to the adjacent pixel units 313P and 314P via the data line D2. Through such scanning method, i.e., to simultaneously scan m (2) adjacent scan lines in the second direction P2 to simultaneously drive m (2) adjacent pixel units, the image resolution of the image signal in the second direction P2 (the vertical direction) may be changed to m times, and the pixel number of the second image data 220 in the second direction P2 may be increased to 2160 (i.e., the vertical resolution is 2160).

It should be noted that an execution sequence of the aforementioned first driving element 1101 and the second driving element 1102 is not limited by the disclosure. According to some embodiments, the first driving element 1101 and the second driving element 1102 may operate simultaneously. According to some embodiments, the first driving element 1101 and the second driving element 1102 may be integrated in a processing unit, for example, integrated in an integrated circuit (IC). According to an embodiment, the driver 110 may include a timing controller (TCON) or other display driving circuits, but the disclosure is not limited thereto. According to some embodiments, the driver 110 may include a gate driving element and a data driving element (not shown). The gate driving element may be coupled to the scan lines to control turning-on of the switching elements. The data driving element may be coupled to the data lines to output data to the data lines. According to some other embodiments, the display panel 120 may include a substrate (not shown), and the switching elements disposed on the substrate. According to still some other embodiments, the gate driving element may be disposed on the substrate. According to some embodiments, the data driving element may be disposed on the substrate.

In some embodiments of the disclosure, the driver 110 may, for example, use a super resolution (SR) algorithm to duplicate each pixel data of A×B pixel data of the first image signal S1 to add as new pixel data adjacent to each pixel data. In other words, the driver 110 may add one or more pixel data to each of the A×B pixel data of the first image signal S1 along at least one of the first direction P1 and the second direction P2, and is not limited to the foregoing n times duplication along the first direction P1. Moreover, in other embodiments of the disclosure, the aforementioned n times may be a positive integer multiple or a non-integer positive multiple. In this regard, if the multiple n is a non-integer positive multiple, the driver 110 may perform image data duplication through, for example, interpolation.

According to some embodiments, it is assumed that an image refresh rate of the first image signal S1 and the second image signal S2 are both 60 hertz (Hz), and based on the aforementioned method that the driver 110 simultaneously scans two adjacent scan lines to simultaneously drive two adjacent pixel units (m=2), when the display panel 120 wants to display a display image, the display panel 120 may scan all of the scan lines of the display panel 120 in half the time. Therefore, the driver 110 may drive the display panel 120 to achieve a display effect with a refresh rate of 120 Hz according to the second image signal S2. In other words, although the driver 110 receives the first image signal S1 with a lower image refresh rate, after converting the first image signal S1 into the second image signal S2 and the driving method described above, the display panel 120 may be driven by the driver 110 to achieve a display effect with a higher image refresh rate.

In addition, in other embodiments of the disclosure, the driver 110 may also implement a function of variable refresh rate (VRR). The driver 110 may adjust the image refresh rate of the display panel 120 according to a frame rate corresponding to the first image signal S1, so that the image refresh rate of the display panel 120 follows the frame rate corresponding to the first image signal S1. Moreover, in some embodiments of the disclosure, the system board 602 may not be additionally provided with, for example, a motion estimate and motion compensation (MEMC) module and a super resolution (SR) computing module, so as to effectively reduce a performance requirement and manufacturing cost of the system board 602 configured in the electronic device 600.

Moreover, in some other embodiments of the disclosure, the driver 110 may also increase the refresh rate autonomously to realize the function of variable refresh rate. In other words, the frame rate corresponding to the first image signal S1 is variable, and the driver 110 may adjust the image refresh rate of the display panel 120 according to the frame rate corresponding to the first image signal S1, so that the image refresh rate of the display panel 120 follows the frame rate corresponding to the first image signal S1. For example, during a process that the driver 110 drives the display panel 120 to display, if an image signal source outside the electronic device 600 finishes drawing a next image in advance (the frame rate of the first image signal S1 becomes higher), the driver 110 does not immediately use image data of the next image for driving, but after a total length of time for the display panel 120 to finish displaying an image, the driver 110 performs driving according to the image data of the next image, so as to avoid image tearing in the display result of the display panel 120. Conversely, during the process that the driver 110 drives the display panel 120 to display, if the image signal source outside the electronic device 600 finishes drawing the next image after exceeding a time length that the display panel 120 displays a current image (the frame rate of the first image signal S1 is decreased), the driver 110 maintains driving the display image displayed by the display panel 120, and does not drive the display panel 120 to display the next image until the driver 111 waits and receives the image data of the finished next image, so as to avoid image display lags or pauses occurred to the display result of the display panel 120. Therefore, the electronic device 600 may be combined with the variable refresh rate function to effectively reduce or eliminate the problem of image display lags, pauses or image tearing, so that the display panel 120 may provide a smoother display effect. However, in still other embodiments of the disclosure, the image refresh rate of the display panel 120 of the embodiment may also be independently adjusted, and it is not necessary to use the frame rate of the first image signal S1 as the basis for adjusting the image refresh rate of the display panel 120 as described above.

As described above, according to some embodiments, the driver 110 may process the image signal with a lower image resolution to obtain an image signal with a higher image resolution, and output the image signal to the display panel 120 so that an image frame displayed by the display panel 120 has the higher image resolution. According to some embodiments, the system board 602 may not need to be additionally provided with a processing unit for processing the resolution of the image signal. For example, the system board 602 does not have a computing module for changing the resolution, for example, does not have a super resolution computing module. In this way, the performance requirement and manufacturing cost of the system board 602 disposed in the electronic device 600 may be reduced.

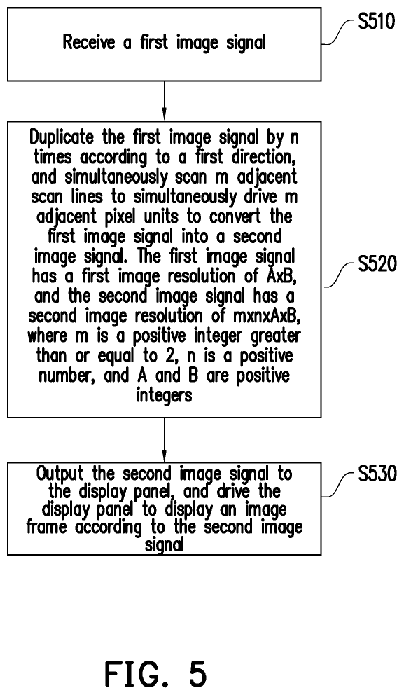

FIG. 5 is a flowchart of a driving method of a display panel according to an embodiment of the disclosure. Referring to FIG. 1 and FIG. 5, the driving method of the embodiment may be at least applicable to the electronic device 600 of the embodiment of FIG. 1, and the electronic device 600 may perform following steps S510-S530. In step S510, the driver 110 receives the first image signal S1. In step S520, the driver 110 duplicates the first image signal S1 by n times according to a first direction, and simultaneously scans m adjacent scan lines to simultaneously drive m adjacent pixel units to convert the first image signal S1 into the second image signal S2. The first image signal S1 has a first image resolution of A×B, and the second image signal S2 has a second image resolution of m×n×A×B, where m is a positive integer greater than or equal to 2, n is a positive number, and A and B are positive integers. In step S530, the driver 110 outputs the second image signal S2 to the display panel 120, and drives the display panel 120 to display an image frame according to the second image signal S2. Therefore, according to the display driving method of the embodiment, even if the driver 110 of the electronic device 600 receives an image signal with a lower image resolution, the display panel 120 of the electronic device 600 may still present a display effect with a high image resolution.

In addition, regarding the related implementation details and internal component features of the electronic device 600 of the embodiment, sufficient instructions, suggestions and implementation descriptions may be obtained by referring to the descriptions of the aforementioned embodiments of FIG. 1 to FIG. 4, and details thereof are not repeated.

In summary, according to some embodiments, the driver may process the image signal with a lower image resolution, and the image frame displayed on the display panel has a higher image resolution. According to some embodiments, the system board does not have a processing unit configured to process the resolution of the image signal, which may reduce the performance requirement and manufacturing cost of the system board.

It will be apparent to those skilled in the art that various modifications and variations can be made to the disclosed embodiments without departing from the scope or spirit of the disclosure. In view of the foregoing, it is intended that the disclosure covers modifications and variations provided they fall within the scope of the following claims and their equivalents.

What is claimed is:

1. An electronic device, comprising:
a display panel, comprising a plurality of scan lines, a plurality of data lines and a plurality of pixel units defined by the plurality of scan lines and the plurality of data lines, wherein the plurality of data lines are arranged along a first direction, wherein the plurality of scan lines comprise m adjacent scan lines, and the m adjacent scan lines are respectively coupled to m adjacent pixel units in the plurality of pixel units, where m is a positive integer greater than or equal to 2; and
a driver, coupled to the display panel, and configured to convert a first image signal into a second image signal, output the second image signal to the display panel, and enable the display panel to display an image frame according to the second image signal,
wherein converting the first image signal into the second image signal comprises: duplicating the first image signal by n times according to the first direction, and simultaneously scanning the m adjacent scan lines to simultaneously drive the m adjacent pixel units, wherein the first image signal has a first image resolution of A×B, and the second image signal has a second image resolution of m×n×A×B, where n is a positive number, and A and B are positive integers.

2. The electronic device as claimed in claim 1, wherein the driver comprises:
a first driving element, configured to duplicate the first image signal by n times according to the first direction.

3. The electronic device as claimed in claim 1, wherein the driver comprises:
a second driving element, configured to simultaneously scan the m adjacent scan lines to simultaneously drive the m adjacent pixel units.

4. The electronic device as claimed in claim 1, wherein an image refresh rate of the display panel is adjustable.

5. The electronic device as claimed in claim 1, wherein a frame rate corresponding to the first image signal is variable.

6. The electronic device as claimed in claim 5, wherein the driver adjusts an image refresh rate of the display panel according to the variable frame rate corresponding to the first image signal.

7. The electronic device as claimed in claim 1, wherein the driver comprises a timing controller.

8. The electronic device as claimed in claim 1, wherein the first image signal and the second image signal have a same image refresh rate.

9. The electronic device as claimed in claim 1, wherein a refresh rate of the image frame displayed by the display panel according to the second image signal is higher than an image refresh rate of the first image signal.

10. A driving method of a display panel, comprising:
duplicating a first image signal by n times according to a first direction, and simultaneously scanning m adjacent scan lines to simultaneously drive m adjacent pixel units to convert the first image signal into a second image signal, wherein the first image signal has a first image resolution of A×B, and the second image signal has a second image resolution of m×n×A×B, where m is a positive integer greater than or equal to 2, n is a positive number, and A and B are positive integers; and
outputting the second image signal to the display panel, and enabling the display panel to display an image frame according to the second image signal.

11. The driving method as claimed in claim 10, wherein an image refresh rate of the display panel is adjustable.

12. The driving method as claimed in claim 10, wherein a frame rate corresponding to the first image signal is variable.

13. The driving method as claimed in claim 12, wherein an image refresh rate of the display panel is adjusted according to the variable frame rate corresponding to the first image signal.
